(19) United States
(12) Patent Application Publication
(10) Pub. No.: US 2025/0226983 A1
(43) Pub. Date: Jul. 10, 2025

(54) DEVICE MANAGEMENT SYSTEM, DEVICE MANAGEMENT METHOD, AND STORAGE MEDIUM

(71) Applicant: CANON KABUSHIKI KAISHA, Tokyo (JP)

(72) Inventor: SATOSHI NISHIKAWA, Kanagawa (JP)

(21) Appl. No.: 18/981,152

(22) Filed: Dec. 13, 2024

(30) Foreign Application Priority Data
Jan. 10, 2024 (JP) 2024-001956

(51) Int. Cl. H04L 9/16; H04L 9/06

(52) U.S. Cl. CPC H04L 9/16; H04L 9/0643

(57) ABSTRACT

An information processing apparatus in which an application for managing information of a network device and an operating system are executed includes: one or more memories storing instructions, and one or more processors capable of executing the instructions causing the information processing apparatus to: cause the application to perform a process for providing a plurality of choices for an algorithm used for cryptographic communication; and cause the application to set an algorithm selected in response to the provision as settings of communication with the network device, wherein a combination of the plurality of choices provided in the process by the application differs between when the operating system is not operating in an FIPS 140 mode and when the operating system is operating in the FIPS 140 mode of FIPS 140-3.

### BACKGROUND OF THE INVENTION

### Field of the Invention

The present invention relates to a device management system, a device management method, and a storage medium.

### Description of the Related Art

In the related art, a device management system and a management device for acquiring and managing data such as operation information of an image forming device (hereinafter referred to as a device) such as a printer or a multifunction peripheral are known. In such a device management system, an address book including a plurality of pieces of information such as a status, set values, firmware, and a mail address of a network device to be managed can be managed.

The device management system can acquire or transmit data from or to a network device to be managed via a network, and communication with the network device is encrypted in acquisition or transmission of information.

Japanese Unexamined Patent Publication No. 2019-29879 discloses a configuration in which an image processing apparatus switches an operation screen provided to an operation terminal device according to a communication level between the image processing apparatus and the operation terminal device for the purpose of security.

On the other hand, there are Federal Information Processing Standards (FIPS) which are standards enacted by the National Institute of Standards and Technology (NIST) which is an agency of the United States government. The FIPS includes versions FIPS 140-2 and FIPS 140-3.

The device management system uses simple network management protocols (SNMP) or various communication protocols for the purpose of monitoring and management of a TCP/IP network environment.

In such protocols, a hash algorithm can be selected from SHA1/SHA2-256/SHA2-384/SHA2-512 and the like. Environments (or subsystems) including network devices which are managed by the device management system do not cope with FIPS 140-3.

### SUMMARY OF THE INVENTION

An information processing apparatus in which an application for managing information of a network device and an operating system are executed includes:
one or more memories storing instructions, and
one or more processors capable of executing the instructions causing the information processing apparatus to:
   cause the application to perform a process for providing a plurality of choices for an algorithm used for cryptographic communication; and
   cause the application to set an algorithm selected in response to the provision as settings of communication with the network device,
wherein a combination of the plurality of choices provided in the process by the application differs between when the operating system is not operating in an FIPS 140 mode and when the operating system is operating in the FIPS 140 mode of FIPS 140-3.

Further features of the present invention will become apparent from the following description of embodiments with reference to the attached drawings.

### BRIEF DESCRIPTION OF THE DRAWINGS

FIG. 1 is a diagram schematically illustrating an example of a configuration of a device management system according to a first embodiment of the present invention.

FIG. 2 is a diagram illustrating an example of a hardware configuration of a device management server 1000 according to the first embodiment.

FIG. 3 is a functional block diagram illustrating an example of a configuration of software modules of the device management server 1000 according to the first embodiment.

FIG. 4 is a functional block diagram illustrating an example of an internal configuration of a device 2000 according to the first embodiment.

FIG. 5 is a diagram illustrating an example of a display UI associated with device search results according to the first embodiment.

FIG. 6A is a diagram illustrating an example of a display UI associated with settings of communication with a device according to the first embodiment.

FIG. 6B is a diagram illustrating an example of a display UI associated with details of authentication information according to the first embodiment.

FIG. 6C is a diagram illustrating an example of a display UI associated with settings of communication with a device according to the first embodiment.

FIG. 7A is a flowchart illustrating an example of a process flow of a device management method according to the first embodiment.

FIG. 7B is a flowchart illustrating an example of a detailed flow of Step S703 in FIG. 7A.

FIG. 7C is a flowchart illustrating an example of a detailed flow of Step S708 in FIG. 7A.

FIG. 7D is a flowchart illustrating an example of a detailed flow of Step S705 in FIG. 7A.

FIG. 8A is a diagram illustrating a display example of an “authentication algorithm” for FIPS 140-3.

FIG. 8B is a diagram illustrating a display example of an “authentication algorithm” for FIPS 140-2.

FIG. 9 is a flowchart illustrating an example of a process flow of a device management method according to a second embodiment.

FIG. 10 is a diagram illustrating another example of a display UI according to the first embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

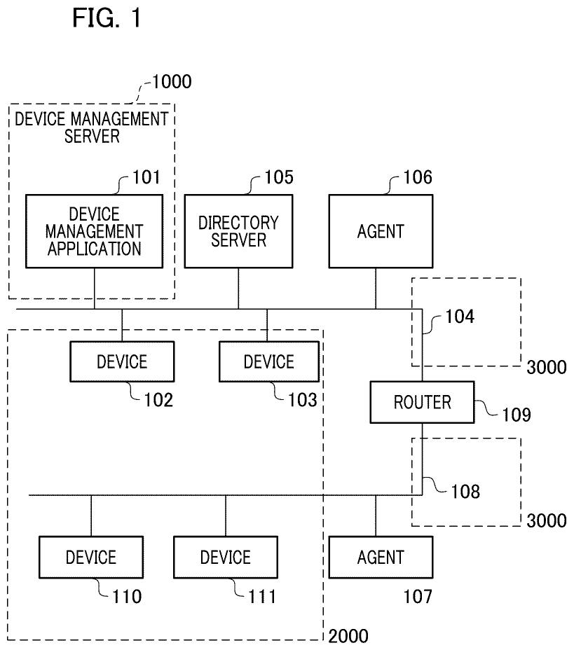

FIG. 1 is a diagram schematically illustrating an example of a configuration of a device management system according to a first embodiment of the present invention. The device management system according to the first embodiment includes one device management server 1000 including a device management application 101 and a plurality of agent applications (hereinafter abbreviated to agents) 106 and 107.

The device management system according to the first embodiment manages devices 102, 103, 110, and 111 (hereinafter collectively referred to as a device 2000) connected to a network. The device management server 1000, the agent 106, and the devices 102 and 103 are connected to each other via a network 104.

The agent 107 and the devices 110 and 111 are connected to each other via a network 108. The network 104 and the network 108 are connected by a router 109 (the networks 104 and 108 are collectively referred to as a communication line 3000).

The router connects the two networks to each other and may be configured, for example, to permit communication between the agent 107 and the device management server 1000 and to prohibit communication with the devices 110 and 111 on the network 108.

Here, the agents 106 and 107 and the devices 102, 103, 110, and 111 are correlated on the basis of addresses of the devices or the like. For example, it is assumed that the agent 106 is correlated with the devices 102 and 103 and the agent 107 is correlated with the devices 110 and 111.

Reference sign 105 denotes a directory server, and the device management server 1000 can be set such that a user of the directory server 105 can access the device management server 1000.

An example in which the device 102 is operated by the agent 106 will be described below. The device management server 1000 instructs the agent 106 to operate the device 102. The agent 106 performs an operation of transmitting a request to the device 102 in accordance with the instruction or the like and transmits a result thereof to the device management server 1000.

Examples of the operation include acquisition of information from the device 102, change of a set value of the device 102, instruction to install an application in the device 102, and instruction to update firmware of the device 102.

The device 102 and the device management server 1000 do not communicate directly with each other, and communication is performed between the device management server 1000 and the agent 106 and between the agent 106 and the device 102.

Two agents and four devices are illustrated in FIG. 1, but a configuration in which several tens of thousands of devices are managed via several tens of agents may be employed. In this case, the configuration or the operations are the same as described in the present embodiment.

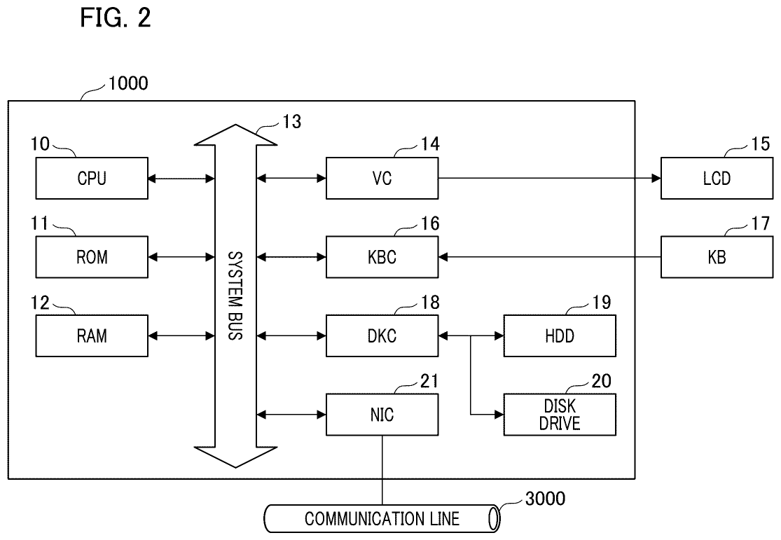

FIG. 2 is a diagram illustrating an example of a hardware configuration of the device management server 1000 according to the first embodiment. A CPU 10 uses a RAM 12 as a work area and executes various computer programs such as an OS or device management software stored in a ROM 11 or an HDD 19. Reference sign 13 denotes a system bus.

The device management server 1000 is connected to a display device (LCD) 15 via a video card (VC) 14 and connected to a keyboard (KB) 17 or a pointing device (not illustrated) such as a mouse via a keyboard controller (KBC) 16.

The device management server 1000 can control a disk drive 20 in which a storage medium such as a CD-ROM, DVD, a magnetic tape, or an IC memory card can be mounted via a disk controller (DKC) 18.

The device management server 1000 can perform data communication with a device on a communication line 3000 via a network interface card (NIC) 21.

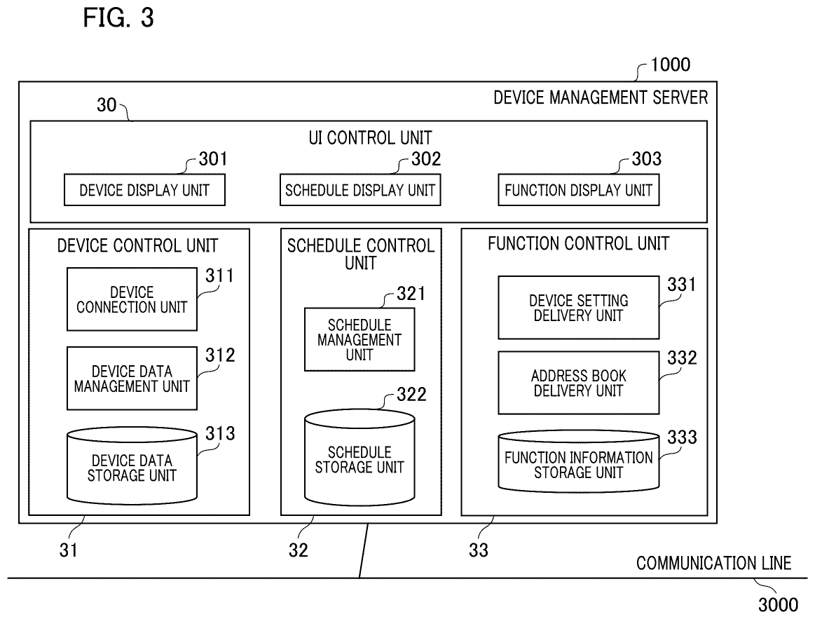

FIG. 3 is a functional block diagram illustrating an example of a software module configuration of the device management server 1000 according to the first embodiment. The device management server 1000 includes a UI control unit 30, a device control unit 31, a schedule control unit 32, and a function control unit 33 as software module constituents for managing the device 2000.

These modules are realized by causing the CPU 10 to execute device management software which is a computer program stored in the RAM 12, the ROM 11, and the HDD 19 illustrated in FIG. 2.

On the other hand, some or all of the modules may be realized by hardware. A dedicated circuit (ASIC), a processor (such as a reconfigurable processor or a DSP), or the like can be used as the hardware.

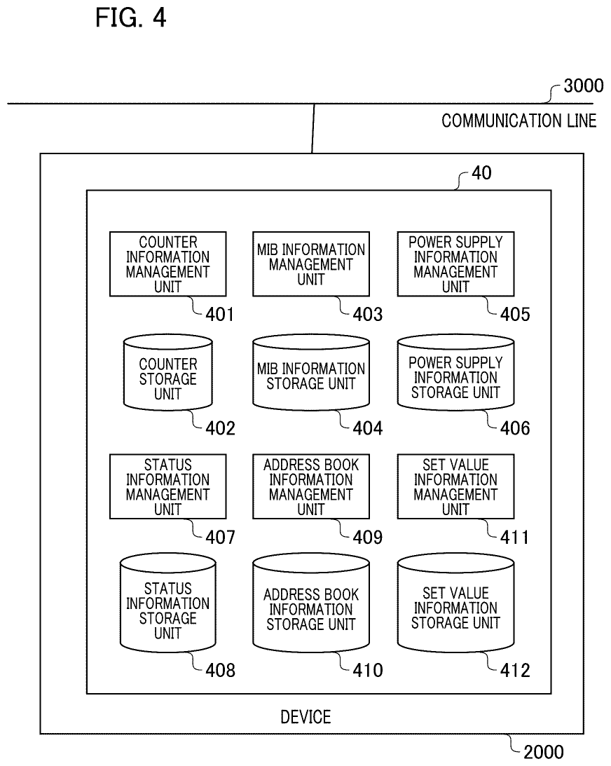

The functional blocks illustrated in FIG. 3 may not be incorporated into the same housing and may be realized by different devices which are connected to each other via a signal line. The aforementioned description with reference to FIG. 3 similarly applies to FIG. 4.

The UI control unit 30 includes a device display unit 301, a schedule display unit 302, and a function display unit 303. The device control unit 31 includes a device connection unit 311, a device data management unit 312, and a device data storage unit 313.

The schedule control unit 32 includes a schedule management unit 321 and a schedule storage unit 322. The function control unit 33 includes a device settings delivery unit 331, an address book delivery unit 332, and a function information storage unit 333.

The UI control unit 30 performs UI control in the device control unit 31, the schedule control unit 32, and the function control unit 33 using the device display unit 301, the schedule display unit 302, and the function display unit 303. The UI control may be realized as a web-based application. In this case, the UI control can be used via a web browser.

The device connection unit 311 has functions such as device search, collection of information from devices, and setting execution. An example of the functions of the device connection unit 311 is a device search function for the devices 2000 using SNMP, IP Broadcast, SLP/Multicast, or the like.

At that time, the device connection unit 311 searches the devices 2000 at an arbitrary timing. Then, the device connection unit 311 has a function of acquiring/changing device information such as management information base (MIB) information or security policy information via the communication line 3000 such as a LAN.

The device connection unit 311 acquires device information such as a device name, a product name, and an IP address as a result of communication setting with respect to the devices 2000 and device search and stores the acquired device information in the device data storage unit 313. The device data management unit 312 manages data in the device data storage unit 313.

The schedule management unit 321 generates and manages a schedule input from the schedule display unit 302 in cooperation with the functions of the function control unit 33 and stores the schedule in the schedule storage unit 322. The device setting delivery unit 331 of the function control unit 33 delivers settings to devices on the basis of an input from the function display unit 303.

The address book delivery unit 332 delivers an address book to devices on the basis of an input from the function display unit 303. At that time, the information is stored in the function information storage unit 333. Here, the device data storage unit 313, the schedule storage unit 322, and the function information storage unit 333 are data recording media such as databases operating on the HDD 19, and a schedule list, a device list, function information, and the like are stored therein.

FIG. 4 is a functional block diagram illustrating an example of an internal configuration of the device 2000 according to the first embodiment and illustrates an example of a software configuration of an information control unit 40 operating in the device 2000. The device 2000 includes an information control unit 40 for managing a plurality of information groups which change dynamically as a software module. The device 2000 according to the first embodiment is, for example, a printer.

A counter information management unit 401 manages the number of print pages or the like and stores the number of print pages in a counter storage unit 402. An MIB information management unit 403 manages MIB information which is the device information and stores the MIB information in an MIB information storage unit 404. A power supply information management unit 405 manages power supply turn-off information or rebooting information and stores the power supply turn-off information or the rebooting information in a power supply information storage unit 406.

A status information management unit 407 manages status information such as online, offline, and errors and stores the status information in a status information storage unit 408. An address book information management unit 409 manages information such as a configuration or data of an address book and stores the information in an address book information storage unit 410. Information of a transmitted address book is also managed and stored therein.

A set value information management unit 411 stores various set values such as settings for printing of a device or settings associated with a network in a set value information storage unit 412. The data is transmitted to the device management server 1000 using SNMP or other protocols in response to a request from the device management server 1000.

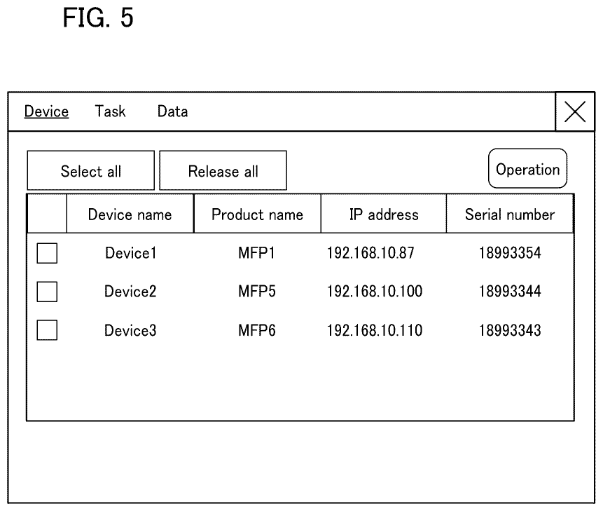

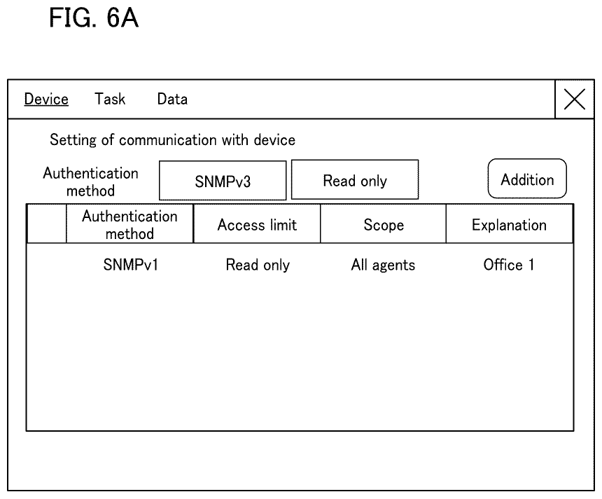

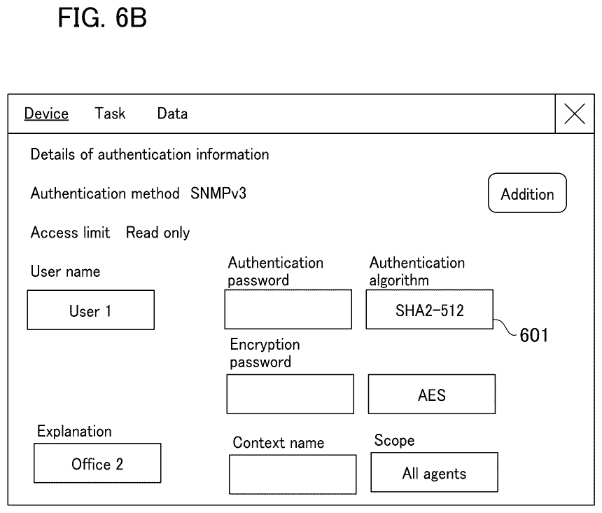

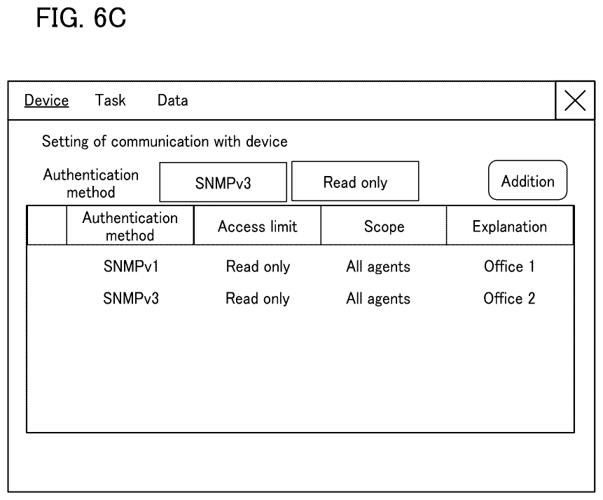

FIG. 5 is a diagram illustrating an example of a display UI associated with device search results according to the first embodiment, and FIGS. 6A to 6C are diagrams illustrating examples of a display UI associated with communication settings according to the first embodiment. A device search process flow will be described below with reference to FIG. 5 and FIGS. 6A to 6C.

The device management server 1000 searches for the devices 2000 to be managed over a network. That is, device search settings are set in a menu “task,” of FIG. 5 and then the device is searched for. SNMP is used as an algorithm for this search.

An example of a UI associated with the device search results is illustrated in FIG. 5. Here, information of such a device (such as a device name, a product name, an IP address, and a serial number) is displayed along with the found device name. In this screen, a specific device may be designated and excluded from a management target.

Before search, communication with a device is set in advance. “Settings of communication with device” is selected in a menu “device.” FIG. 6A is a diagram illustrating an example of a UI for settings of communication with a device. Here, necessary settings such as SNMPv1, SNMPv3, and user authentication settings are set as authentication settings.

SNMPv1 is already set as an authentication method in the example illustrated in FIG. 6A. Here, when SNMPv3 is performed, SNMPv3 is selected as the authentication method, for example, “read only” is selected as an access limit, and a button “addition” is clicked.

When the button “addition” in FIG. 6A is clicked, a detailed screen of authentication information is displayed. FIG. 6B is a diagram illustrating an example of a display UI associated with details of authentication information according to the first embodiment. In FIG. 6B, “user name,” “authentication password,” “encryption password,” “context name,” “scope” (target agent scope), and “explanation” are input, and a button “addition” in FIG. 6B is clicked. Accordingly, a new authentication method is added, and the screen is switched to a screen illustrated in FIG. 6C. FIG. 6C is a diagram illustrating an example of a display UI associated with settings of communication with a device according to the first embodiment.

In FIG. 6B, one of SHA1/SHA2-256/SHA2-384/SHA2-512 can be selected as a hash algorithm in “authentication password.” Device search and information acquisition are performed on the basis of communication settings set in advance in this way.

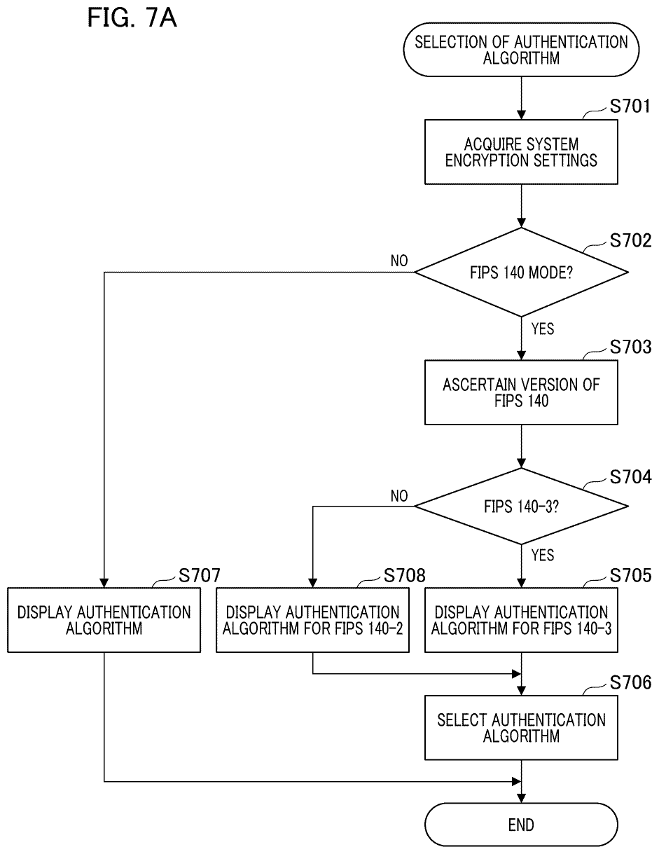

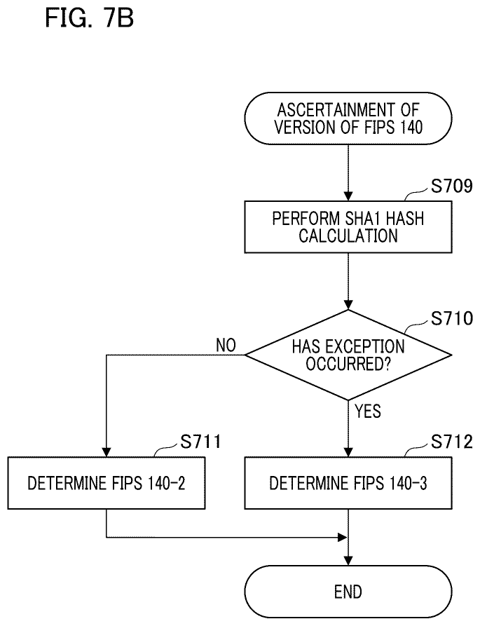

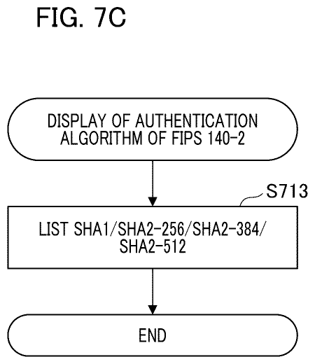

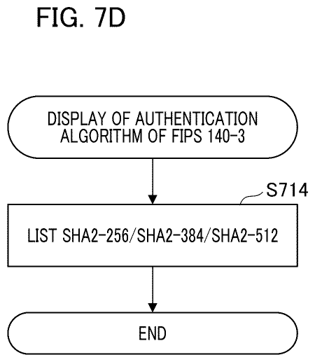

FIG. 7A is a flowchart illustrating an example of a process flow of a device management method according to the first embodiment. In the present embodiment, the device management server 1000 illustrated in FIG. 1 performs a device management method of managing a plurality of devices connected to a network.

Operations of steps in the flowcharts illustrated in FIGS. 7A to 7D are sequentially performed by causing a CPU or the like which is a computer in the device management server 1000 to execute device management software which is a computer program stored in a memory.

When the device management server 1000 manages devices, device search is first performed as described above with reference to FIG. 5. Communication with the devices is set before that. That is, “setting of communication with device” is selected in the button “device” in FIG. 5. Then, in the device communication setting screen illustrated in FIG. 6A, the authentication method “SNMPv3” is selected and the button “addition” is clicked as described above.

When a choice display 601 of “authentication algorithm” of “authentication password” in FIG. 6B is clicked, the device connection unit 311 acquires system encryption settings in Step S701 in FIG. 7A.

That is, in the device management system, the device management server 1000 acquires information on whether an operating windows is operating in an FIPS 140 mode. Here, Step S701 serves as an encryption setting acquisition step (an encryption setting acquisition means).

In Step S702, the device connection unit 311 determines whether the device management system is operating in the FIPS 140 mode on the basis of the information acquired in Step S701. When the determination result of Step S702 is YES, the process flow proceeds to Step S703. Otherwise, the process flow proceeds to Step S707. Here, Step S702 serves as a first determination step (a first determination means) of determining whether the device management system is in the FIPS 140 mode.

In Step S703, the device connection unit 311 ascertains the version of FIPS 140. Here, Step S703 serves as a version ascertainment step (a version ascertainment means) of ascertaining the version of FIPS 140.

In Step S704, the device connection unit 311 determines whether the version of FIPS 140 is FIPS 140-3. Here, Step S704 serves as a second determination step (a second determination means) of determining whether the version of FIPS 140 is FIPS 140-3.

When the determination result of Step S704 is YES, the process flow proceeds to Step S705. Otherwise, the process flow proceeds to Step S708.

In Step S705, the device display unit 301 displays an “authentication algorithm” for FIPS 140-3. In Step S706, the device connection unit 311 selects the “authentication algorithm,” and the screen is returned to the authentication information details screen. Here, Step S706 serves as a selection step (a selection means) of selecting an authentication algorithm displayed by an authentication algorithm display step (an authentication algorithm display means).

In Step S707, the device display unit 301 displays a normal authentication algorithm. In Step S708, the device display unit 301 displays the authentication algorithm for FIPS 140-2.

Here, Steps S705, S707, and S708 serve as an authentication algorithm display step (an authentication algorithm display means) of displaying an authentication algorithm based on the determination results from the first determination means and the second determination means. The authentication algorithm display means can display the authentication algorithm for FIPS 140-3 and the authentication algorithm for FIPS 140-2.

FIG. 7B is a flowchart illustrating an example of a detailed process flow of Step S703 in FIG. 7A, and the device connection unit 311 performs SHA1 hash calculation in Step S709 in ascertaining the version of FIPS 140 in Step S703.

Subsequently, in Step S710, the device connection unit 311 determines whether an exception has occurred. More specifically, the device connection unit 311 performs SHA1 hash calculation using a library of the operating system.

At that time, when the operating system is operating in the FIPS 140-3 mode, an exception is returned to the device connection unit 311 as a result of calculation. For example, when the operating system is Windows11 or the like, a value InvalidOperationException is returned as the exception.

The device connection unit 311 determines whether an exception has occurred on the basis of this process. Steps S709 and S710 serve as a third determination step (a third determination means) of performing SHA1 hash calculation and determining whether an exception has occurred.

When the determination result of Step S710 is YES, the process flow proceeds to Step S712. Otherwise, the process flow proceeds to Step S711.

In Step S711, the device connection unit 311 determines that the version is FIPS 140-2, ends the process flow illustrated in FIG. 7B, and causes the process flow to Step S704. On the other hand, in Step S712, the device connection unit 311 determines that the version is FIPS 140-3, ends the process flow illustrated in FIG. 7B, and causes the process flow to Step S704.

That is, the device connection unit 311 determines that the version of the operating system is operating in the FIPS 140-3 mode when the third determination means determine that an exception has occurred and determines that the version of the operating system is operating in the FIPS 140-2 mode when the third determination means determine that an exception has not occurred

FIG. 7C is a flowchart illustrating an example of a detailed process flow of Step S708 in FIG. 7A. In displaying the authentication algorithm for FIPS 140-2 in Step S708, SHA1/SHA2-256/SHA2-384/SHA2-512 are displayed (in a list) in Step S713.

That is, when the authentication algorithm for FIPS 140-2 is displayed, at least one of SHA2-256, SHA2-384, and SHA2-512 along with SHA1 is displayed. Thereafter, the process flow illustrated in FIG. 7C ends, and the process flow proceeds to Step S706.

FIG. 7D is a flowchart illustrating an example of a detailed process flow of Step S705 in FIG. 7A. In displaying the authentication algorithm for FIPS 140-3 in Step S705, SHA2-256/SHA2-384/SHA2-512 are displayed (in a list) in Step S714.

That is, when the authentication algorithm for FIPS 140-3 is displayed, at least one of SHA2-256, SHA2-384, and SHA2-512 is displayed. Thereafter, the process flow illustrated in FIG. 7D ends, and the process flow proceeds to Step S706.

In the present embodiment, it is possible to determine in what FIPS version the operating system is operating and to change display or selection of the SNMPv3 hash algorithm.

Operations in the example of a UI will be supplementarily described below with reference to FIGS. 5 to 8. Here, it is assumed that Windows is operating in the FIPS 140-3 mode. As described above, before device management, “settings of communication with device” is selected in the menu “device” in FIG. 5 to set communication with the devices.

In the “device communication setting” screen illustrated in FIG. 6A, “SNMPv3” is selected as the authentication method, and the button “addition” is clicked. The selection display 601 of “authentication algorithm” in “authentication password” is clicked in the “details of authentication information” screen illustrated in FIG. 6B.

Then, it is determined through Steps S701 and S702 that the operating system is operating the FIPS 140 mode, and SHA1 hash calculation of Step S709 in FIG. 7B is performed in ascertaining the FIPS 140 version in Step S703.

Since Windows is operating in the FIPS 140-3 mode, SHA1 is a non-operable algorithm, and an exception (an error) occurs in SHA1 hash calculation. Accordingly, through Steps S710 and S712, it is determined that the operating system is operating in the FIPS 140-3 mode.

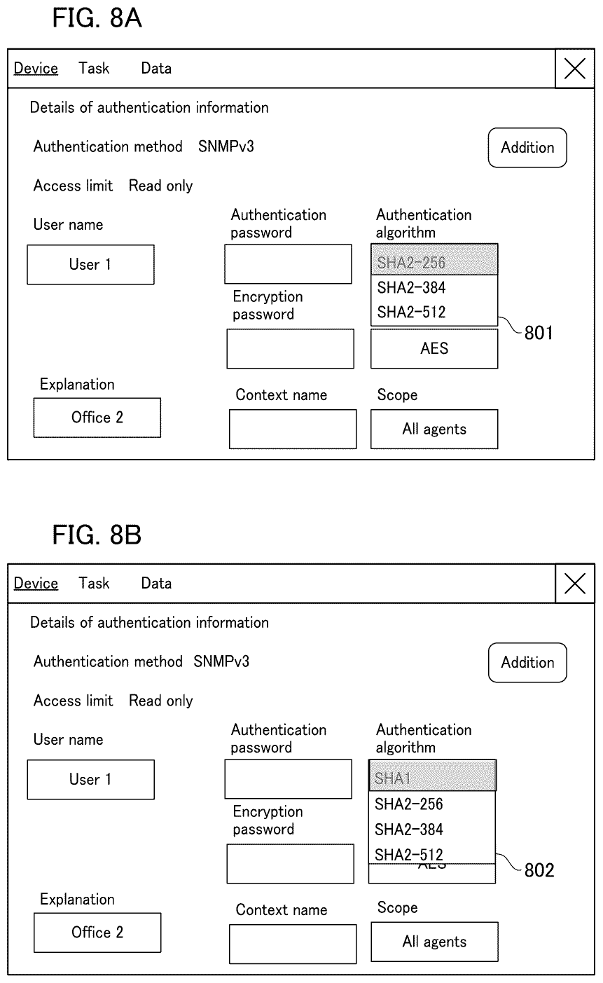

Thereafter, the “authentication algorithm” for FIPS 140-3 is displayed in Steps S704 and S705. FIG. 8A is a diagram illustrating a display example of an “authentication algorithm” for FIPS 140-3. As indicated by 801 in FIG. 8A, SHA2-256/SHA2-384/SHA2-512 are listed through the process of Step S714.

The settings of communication with devices illustrated in FIG. 6C are stored in Step S706 by selecting one of the listed algorithms and then adding the selected one to the device communication setting screen.

When Windows is operating in the FIPS 140-2 mode, an exception (an error) does not occur in SHA1 hash calculation of Step S709, and thus it is determined that the operating system is operating in the FIPS 140-2 mode. Through Steps S704 and S708, the “authentication algorithm” for FIPS 140-2 is displayed.

FIG. 8B is a diagram illustrating a display example of an “authentication algorithm” for FIPS 140-2. As indicated by 802 in FIG. 8B, SHA1/HA2-256/SHA2-384/SHA2-512 are listed through the process of Step S713.

Similarly, the settings of communication with devices illustrated in FIG. 6C are stored in Step S706 by selecting one of the listed algorithms and then adding the selected one to the device communication setting screen. As described above, according to the present embodiment, when an operation of setting the FIPS 140-3 version is performed through the aforementioned series of operations, SHA1 can be excluded from the display of choices.

### Second Embodiment

In a second embodiment, when SHA1 is excluded through update of device information based on algorithm settings stored in advance in the FIPS operation mode, it is assumed that the FIPS version is updated due to update of Windows or devices or the like. Then, an icon or a warning is displayed to prompt a user to transition to a communication setting screen.

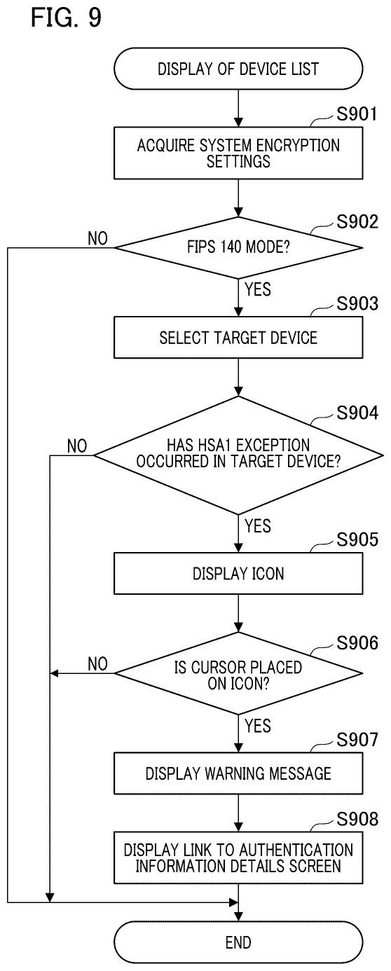

FIG. 9 is a flowchart illustrating an example of a process flow in a device management method according to the second embodiment. The process flow illustrated in FIG. 9 is realized by causing the CPU 10 which is a computer to execute device management software stored in a memory which is a storage medium.

Similarly to the first embodiment, it is assumed that communication with devices is set as illustrated in FIG. 6C. It is also assumed that devices are already searched for and managed as illustrated in the device list display screen of FIG. 5 and periodic device update is set.

The process flow illustrated in FIG. 9 starts when the device list illustrated in FIG. 5 is displayed. In Step S901 of FIG. 9, the device connection unit 311 acquires system encryption settings. In Step S902, the device connection unit 311 determines whether the device management system is in the FIPS 140 mode on the basis of the information acquired in Step S901.

When the determination result of Step S902 is YES, the process flow proceeds to Step S903. When the determination result of Step S902 is NO, the process flow illustrated in FIG. 9 ends, and the device list display screen continues to be displayed. It is assumed that the processes of Steps S901 to S908 in FIG. 9 are periodically repeated.

In Step S903, the device connection unit 311 selects a target device for which an icon and a warning are to be displayed according to a user's operation. Here, Step S903 serves as a device selection step (a device selection means) of selecting a target device.

In Step S904, the device connection unit 311 determines whether an exception of SHA1 has occurred in the target device selected in Step S903. Here, Step S904 serves as an exception determination step (an exception determination means) of determining whether an exception of SHA1 has occurred in the target device.

When the determination result of Step S903 is YES, the process flow proceeds to Step S905. When the determination result of Step S903 is NO, the process flow illustrated in FIG. 9 ends, and the device list screen continues to be displayed.

In Step S905, the device display unit 301 displays an icon. In Step S906, the device display unit 301 determines whether a cursor is placed on the icon displayed in Step S905.

When the determination result of Step S906 is YES, the process flow proceeds to Step S907. When the determination result of Step S906 is NO, the process flow illustrated in FIG. 9 ends, and the device list screen continues to be displayed. In Step S907, the device display unit 301 displays a warning message. In Step S908, the device display unit 301 displays a link to the authentication information details screen.

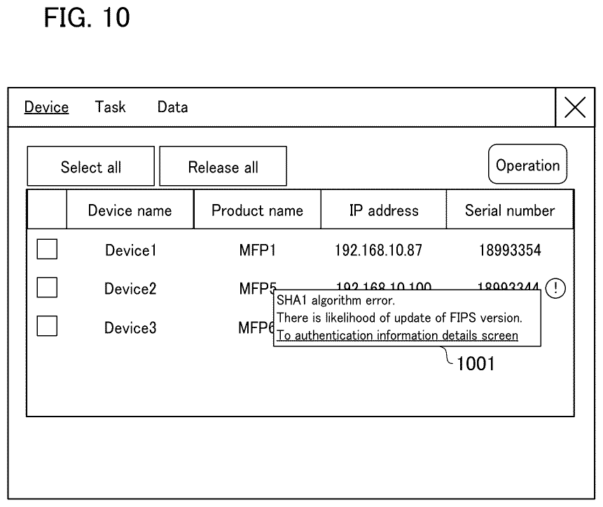

The operations according to the second embodiment illustrated in FIG. 9 will be supplementarily described below with reference to the examples of the UI illustrated in FIG. 5, FIGS. 6A to 6C, and FIG. 10. It is assumed that SNMPv3 communication settings are set as illustrated in FIG. 6C. It is assumed that the operating system has operated in the FIPS 140-2 mode before that and SHA1 has been set as the authentication algorithm thereof. It is also assumed that devices are searched for and managed as in the device list display screen illustrated in FIG. 5 and periodic device update is set.

It is determined in Steps S901 and S902 of FIG. 9 that the operating system is operating in the FIPS 140 mode and, for example, it is assumed that Device2 in FIG. 5 is selected in Step S903. Then, in Step S904, it is determined whether an SHA1 exception has occurred.

Here, it is assumed that an exception has occurred. Then, in Step S905, an icon is displayed. This example is illustrated in FIG. 10. For example, an icon “!” is displayed at the right end of the row of Device2.

In Step S906, it is determined whether a cursor is placed on the icon. Here, it is assumed that a user moves the cursor onto the icon. Then, the determination result of Step S906 is YES.

Then, in Step S907, a warning message is displayed. That is, as illustrated in FIG. 10, for example, a message 1001 such as “SHA1 algorithm error. There is a likelihood that the FIPS version has been updated.” is displayed below the icon of Device 2.

In Step S908, a link “to authentication information details screen” is displayed as indicated by the message 1001 in FIG. 10, and the screen transitions to the “authentication information details” screen (an authentication information setting screen) as illustrated in FIGS. 6B, 8A, and 8B by clicking the link. Then, it is possible to change settings of the authentication algorithm.

Here, Steps S904 to S908 serve as a notification step (a notification means) of notifying a user when it is determined in the exception determination step (the exception determination means) that an SHA1 exception has occurred. The notification means has only to display at least one of an icon, a warning, and a link to an authentication information setting screen.

In the second embodiment, when SHA1 is excluded through update of device information based on algorithm settings stored in advance through this process flow, it is assumed that the FIPS version is updated due to update of Windows or devices or the like. Then, an icon or a warning is displayed to prompt a user to transition to a communication setting screen.

As described above, according to the first embodiment, it is possible to prevent an algorithm which cannot operate in the Windows environment corresponding to FIPS 140-3 from being set. According to the second embodiment, when update of device information based on algorithm settings stored in advance fails, it is possible to determine that the corresponding FIPS version has been updated due to update of Windows or devices or the like and to prompt a user to correct authentication information.

### OTHER EMBODIMENTS

The present invention may be applied to a system including a plurality of devices (for example, a host computer, an interface device, a reader, and a printer) or may be applied to a single complex machine (for example, a multifunction peripheral of a copier and a facsimile device).

The present invention can also be realized by supplying a recording medium storing program codes for realizing the functions according to the aforementioned embodiments to a system or a device and causing a computer of the system or the device to read and execute the program codes stored in the storage medium.

In this case, the program codes read form the storage medium realize the functions according to the aforementioned embodiments, and the program codes and the storage medium storing the program codes constitute the present invention.

The present invention includes a case in which an operating system (OS) operating in a computer perform some or all of the actual processes in accordance with instructions of the program codes and the functions according to the aforementioned embodiments are realized through these processes.

The present invention is also applied to a case in which the program codes read from the storage medium are written to a function extension card inserted into the computer or a memory included in a function extension unit connected to the computer.

In this case, a CPU or the like provided in the function extension card or the function extension unit may perform some or all of the actual processes in accordance with instructions of the written program codes, and the functions according to the aforementioned embodiments may be realized through these processes.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-001956, filed on Jan. 10, 2024, which is hereby incorporated by reference herein in its entirety.

What is claimed is:

1. An information processing apparatus in which an application for managing information of a network device and an operating system are executed, the information processing apparatus comprising:
one or more memories storing instructions, and
one or more processors capable of executing the instructions causing the information processing apparatus to:
cause the application to perform a process for providing a plurality of choices for an algorithm used for cryptographic communication; and
cause the application to set an algorithm selected in response to the provision as settings of communication with the network device,
wherein a combination of the plurality of choices provided in the process by the application differs between when the operating system is not operating in an FIPS 140 mode and when the operating system is operating in the FIPS 140 mode of FIPS 140-3.

2. The information processing apparatus according to claim 1, wherein the plurality of choices provided in the process by the application does not include SHA1 when the operating system is operating in the FIPS 140 mode of FIPS 140-3, and
wherein the plurality of choices provided in the process by the application includes SHA1 when the operating system is not operating in the FIPS 140 mode of FIPS 140-3.

3. The information processing apparatus according to claim 2, wherein the plurality of choices provided in the process by the application includes at least two of SHA2-256, SHA2-384, and SHA2-512 when the operating system is operating in the FIPS 140 mode of FIPS 140-3.

4. The information processing apparatus according to claim 1, wherein the case in which the operating system is not operating in the FIPS 140 mode of FIPS 140-3 includes a case in which the operating system is operating in the FIPS 140 mode of FIPS 140-2.

5. The information processing apparatus according to claim 4, wherein the plurality of choices provided in the process by the application includes at least one of SHA2-256, SHA2-384, and SHA2-512 in addition to SHA1 when the operating system is operating in the FIPS 140 mode of FIPS 140-2.

6. The information processing apparatus according to claim 1, wherein the instructions further cause the information processing apparatus to cause the application to determine whether the operating system is operating in the FIPS 140 mode of FIPS 140-3, and
wherein it is determined that the operating system is operating in the FIPS 140 mode of FIPS 140-3 when an exception occurs at the time of performing a process of a predetermined algorithm using a library of the operating system.

7. A method that is performed by an information processing apparatus in which an application for managing information of a network device and an operating system are executed, the method comprising:
causing the application to perform a process for providing a plurality of choices for an algorithm used for cryptographic communication; and
causing the application to set an algorithm selected in response to the provision as settings of communication with the network device,
wherein a combination of the plurality of choices provided in the process by the application differs between when the operating system is not operating in an FIPS 140 mode and when the operating system is operating in the FIPS 140 mode of FIPS 140-3.

8. A non-transitory computer-readable storage medium configured to store a computer program to control an information processing apparatus in which an application for managing information of a network device and an operating system are executed, wherein the computer program comprises instructions for executing following processes:
causing the application to perform a process for providing a plurality of choices for an algorithm used for cryptographic communication; and
causing the application to set an algorithm selected in response to the provision as settings of communication with the network device,
wherein a combination of the plurality of choices provided in the process by the application differs between when the operating system is not operating in an FIPS 140 mode and when the operating system is operating in the FIPS 140 mode of FIPS 140-3.
